(19) United States
(12) Patent Application Publication
(10) Pub. No.: US 2018/0224583 A1
(43) Pub. Date: Aug. 9, 2018

(54) OPTICAL STRUCTURE, METHOD FOR MANUFACTURING OPTICAL STRUCTURE, DISPLAY SUBSTRATE AND DISPLAY DEVICE

(71) Applicants: BOE TECHNOLOGY GROUP CO., LTD., Beijing (CN); HEFEI BOE OPTOELECTRONICS TECHNOLOGY CO., LTD., ANHUI (CN)

(72) Inventors: Zhi LIU, Beijing (CN); Yuanhui GUO, Beijing (CN)

(73) Assignees: BOE TECHNOLOGY GROUP CO., LTD., Beijing (CN); HEFEI BOE OPTOELECTRONICS TECHNOLOGY CO., LTD., ANHUI (CN)

(21) Appl. No.: 15/510,976

(22) PCT Filed: Sep. 5, 2016
(86) PCT No.: PCT/CN2016/098058

§ 371 Date: Mar. 13, 2017

(30) Foreign Application Priority Data
Oct. 29, 2015 (CN) 201510717534.0

(51) Int. Cl. G02B 5/04

(52) U.S. Cl. CPC G02B 5/045; G02F 1/1335

(57) ABSTRACT

The present disclosure provides an optical structure and a method for manufacturing the same, a display substrate and a display device. The optical structure includes at least two adjacent optical films. The refractive indexes of the at least two adjacent optical films are different. When incident light enters the two adjacent optical films having the different refractive indexes, the light is refracted at a contact interface between the two adjacent optical films and an angle between the refracted light and the incident surface is larger than that between the incident light and the incident surface, so as to achieve the convergence of the light.

### CROSS-REFERENCE TO RELATED APPLICATION

The present application claims the priority of Chinese Patent Application No. 201510717534.0 filed on Oct. 29, 2015, the disclosure of which is incorporated herein by reference.

### TECHNICAL FIELD

The present disclosure relates to the field of display technology, in particular to an optical structure, a method for manufacturing the optical structure, a display substrate and a display device.

### BACKGROUND

Liquid crystal display technology is the mainstream of flat panel display technology. Since the liquid crystal itself does not emit light, various liquid crystal display devices, such as liquid crystal displays (LCDs) and liquid crystal TVs, rely on an external backlight for display.

When a liquid crystal display device is used for outdoor display, in order to improve a display quality of the liquid crystal display device, it needs to further increase the brightness, so as to prevent the display from being affected by the external ambient light. In the related art, an optical element, such as a prism sheet or a brightness enhancement film, is used to increase the brightness of the liquid crystal display device. However, this will increase the thickness of the entire device, and thus cannot satisfy a demand for a thinner product. Moreover, when the optical element gets thinner, the reliability of the LCD device is adversely affected to a certain extent, and the total cost of the entire LCD device is increased.

### SUMMARY

The present disclosure provides an optical structure, so as to improve the brightness of the display device without increasing the thickness of the display module.

The present disclosure further provides a method for manufacturing the optical structure, and provides a display substrate and a display device including the above optical structure.

In one aspect, the present disclosure provides in some embodiments an optical structure. The optical structure includes at least two light-transmissible optical films. At least two adjacent light-transmissible optical films have different refractive indexes. When incident light enters into the two adjacent optical films with different refractive indexes, the light is refracted at a contact interface of the two adjacent optical film, so as to achieve the convergence of light.

The present disclosure further provides in some embodiments a display substrate. The display substrate includes the above-mentioned optical structure. The optical structure is arranged on the display substrate at a light-entering side.

The present disclosure further provides in some embodiments a display device, including the above-mentioned display substrate.

The above-described technical solutions of the present disclosure have the following advantages. In the above-described embodiment, the optical structure is provided with two adjacent optical films having different refractive indexes, and when incident light enters the two adjacent optical films, refraction occurs at the contact interface of the adjacent optical films. As a result, an angle between the refracted light and the light incident surface is greater than that between the incident light and the light incident surface, so as to realize the convergence of light. Since a thickness of the optical film is in a nanometer order, when the optical structure is applied to the display device, the display brightness can be increased without increasing the thickness of the display module.

### BRIEF DESCRIPTION OF THE DRAWINGS

In order to illustrate the technical solutions of the present disclosure in a clearer manner, the drawings desired for the present disclosure will be described hereinafter briefly. Obviously, the following drawings merely relate to some embodiments of the present disclosure, and based on these drawings, a person skilled in the art may obtain the other drawings without any creative effort.

FIG. 1 is a schematic diagram showing an optical structure according to some embodiments of the present disclosure;

FIG. 2 is a schematic diagram showing a projection of a contact interface between a first optical film and a second optical film of the optical structure in FIG. 1 on a light incident surface;

FIG. 3 is another schematic diagram showing the optical structure according to some embodiments of the present disclosure;

FIG. 4 is a schematic diagram showing a projection of a contact interface between a first optical film and a second optical film of the optical structure in FIG. 3 on a light incident surface;

FIG. 5 is still another schematic diagram showing the optical structure according to some embodiments of the present disclosure;

FIGS. 6-8 are schematic diagrams showing a process for manufacturing an optical structure according to some embodiments of the present disclosure;

FIG. 9 is a schematic diagram showing a display substrate according to some embodiments of the present disclosure;

FIG. 10 is another schematic diagram showing the display substrate according to some embodiments of the present disclosure;

FIG. 11 is a schematic diagram showing a display device according to some embodiments of the present disclosure; and

FIG. 12 is another schematic diagram showing the display device according to some embodiments of the present disclosure.

### DETAILED DESCRIPTION

The present disclosure provides an optical structure, which includes at least two light-transmissible optical films. At least two adjacent optical films of the at least two light-transmissible optical films have different refractive indexes. When incident light enters the two adjacent optical film having different refractive indexes, the light is refracted at a contact interface between the two adjacent optical films, such that an angle between the refracted light and an incident surface is larger than that between the incident light and the incident surface, so as to achieve the convergence of light and improve the brightness of light. Since a thickness of the optical film may be in a nanometer (nm) order, when the optical structure is applied to the display device, the display brightness can be increased without increasing the thickness of the display module. In addition, since the thin-film preparation technique has been matured, the production cost of the optical structure is low.

The optical structure may be, but not limited to, applied in liquid crystal display devices and organic light emitting diode display devices.

The present disclosure will be described hereinafter in further details in conjunction with the drawings and embodiments. The following embodiments are for illustrative purposes only, but shall not be used to limit the scope of the present disclosure.

Referring to FIG. 1 and FIG. 3, an optical structure 1 in an embodiment of the present disclosure is used to converge light, to increase the display brightness.

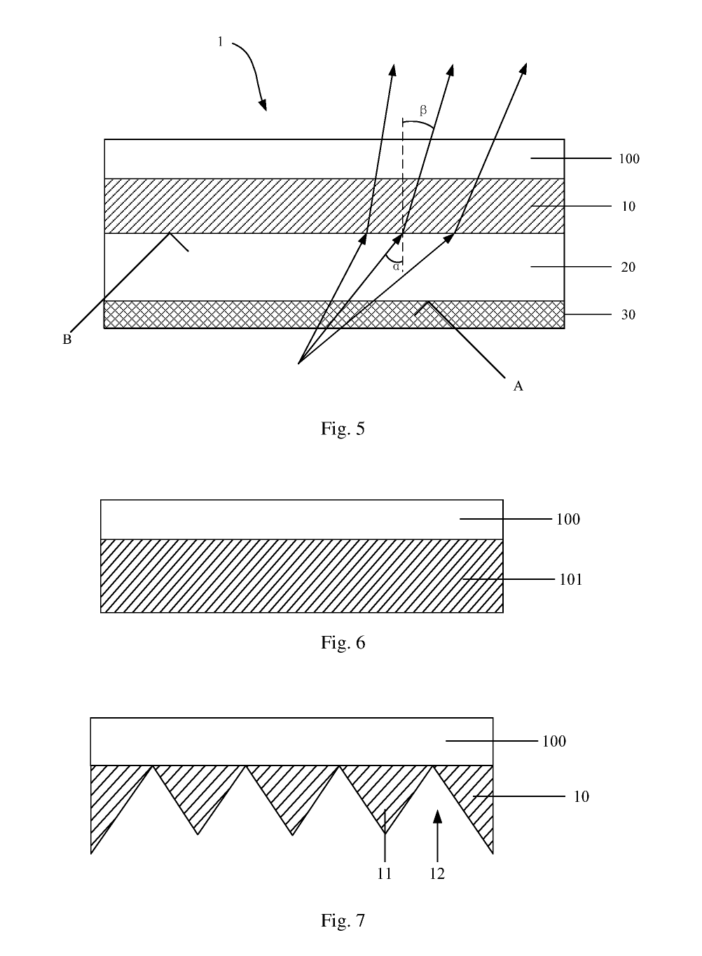

The optical structure 1 includes at least two light-transmissible optical films arranged one on another. At least two adjacent light-transmissible optical films, e.g. a first optical film 10 and a second optical film 20, have different refractive indexes. An incident surface through which incident light enters the two adjacent optical films having the different refractive indexes is referred to be a first incident surface A. When incident light enters the two adjacent optical films having the different refractive indexes, the light is refracted at a contact interface (B₁ and B₂ in FIG. 3, and B in FIG. 5) between the two adjacent optical films. Therefore, an angle between the refracted light and the first incident surface A is larger than that between the incident light and the first incident surface A, so as to achieve the convergence of light and improve the brightness of the light.

The optical film may be made of organic material, such as organic resin. In the drawings, only two adjacent optical films 10 and 20 having different refractive indexes are shown schematically to explain the principle of converging light according to the technical solution of the present disclosure. Other optical films stacked in layers are not shown. The dotted line in the drawing is the normal line of the contact interface between the first optical film 10 and the second optical film 20 which are adjacent to each other and have different refractive indexes. The direction of the straight line with an arrow is the propagation direction of the light.

It should be noted that, the two adjacent optical films refers to that the two optical films are arranged one on another and there is no other film arranged therebetween.

In order to facilitate the description of the technical solution of the present disclosure, the light incident surface in the embodiments of the present disclosure refers to an incident surface through which incident light enters the two adjacent optical films having different refractive indices; the refracted light refers to the light refracted by the two adjacent optical films having different refractive indices; and in the embodiments of the present disclosure, the angles are all acute angles.

In some embodiments of the present disclosure, the two adjacent optical films having different refractive indexes are the first optical film 10 and the second optical film 20, and the second optical film 20 is arranged proximate to the light-entering side.

In the practical application, the refractive indexes of the first optical film 10 and the second optical film 20 may be arranged according to a shape of a contact interface between the first optical film 10 and the second optical film 20, such that after the light is refracted by the second optical film 20 and the first optical film 10 (the light is refracted at the contact interface between the second optical film 20 and the first optical film 10), the angle between the refracted light and the first incident surface A is larger than the angle between the incident light and the first incident surface A, so as to achieve the convergence of light.

In some embodiments, as shown in FIG. 1, the contact interface between the first optical film 10 and the second optical film 20 are arranged to be of a concavo-convex structure, and the second optical film 20 is arranged proximate to the light-entering side. Specifically, the contact interface includes convex surfaces towards the light-exiting side and concave surfaces towards the light-entering side, and the convex surfaces and the concave surfaces are arranged alternately. Further, the refractive index of the second optical film 20 is larger than that of the first optical film 10, such that an incident angle α between a normal line of the convex surface and the light entering the convex surface is less than an exit angle β between the normal line of the convex surface and the light exiting from the convex surface. Therefore, the angle between the incident light entering the second optical film 20 and the first optical film 10 and the first incident surface A is less than the angle between the refracted light and the first incident surface A, so as to achieve the convergence of light. As a result, it is able to converge the light and improve the brightness of the light in a significant manner.

Further, as shown in FIG. 3, an angle γ between the first incident surface A and a tangential plane of the contact interface (including the convex and concave surfaces) between the first optical film 10 and the second optical film 20 satisfies 0°<γ≤45°, such that the angle between the normal line of the first incident surface A and the refracted light ranges from 0° to 45°, thereby reduce an area irradiated by the light and increase the brightness of light.

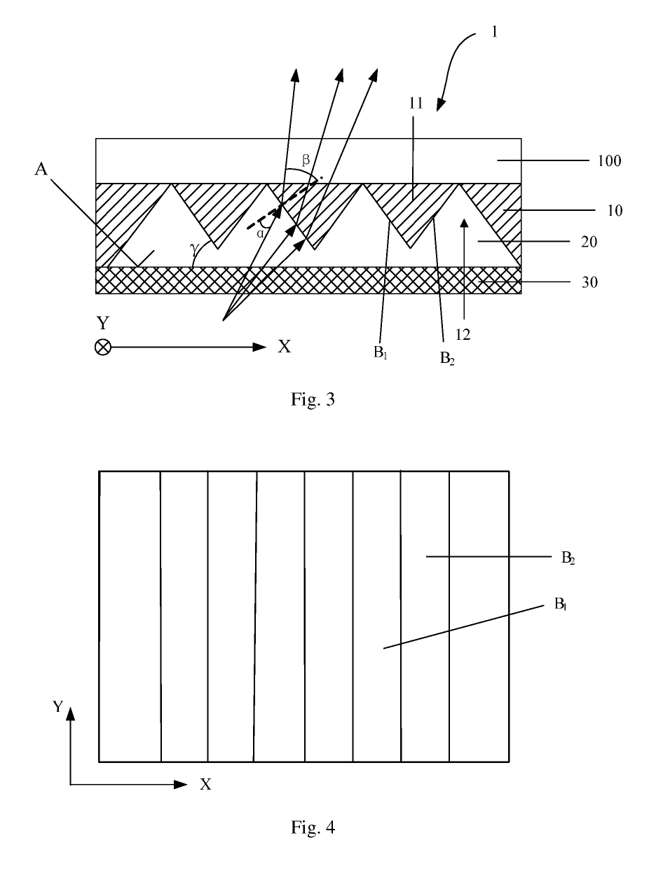

In some embodiments of the present disclosure, referring to FIG. 3 and FIG. 4, the contact interface between the first optical film 10 and the second optical film 20 includes a plurality of first protrusion units protruding toward the light-exiting side. The plurality of first protrusion units is arranged in a first direction X, and each of the first protrusion units is a strip-like protrusion extending in a second direction Y. Here, the first direction X is perpendicular to the second direction Y, and a plane where the first direction X and the second direction Y are located is parallel with the first incident surface A.

Specifically, projections of the first protrusion units on a first vertical plane form a broken line and the first vertical plane is perpendicular to the first incident surface A and parallel to the first direction X. As shown in FIG. 3, in this embodiment, each of the first protrusion units is of a prism-like structure. Optionally, the broken line includes first portions B₁ and second portions B₂ arranged alternately. At this time, each of the first protrusion units is of a triangular prism-like structure. An angle between each of the first portions B₁ and the first incident surface A ranges from 0° to 45°, optionally, is 45°. An angle between each of the second portions B₂ and the first incident surface A ranges from 0° to 45°, optionally, is 45°. In the practical applications, the angle between each of the first portions B₁ and the first incident surface A and the angle between each of the second portions B₂ and the first incident surface A may be arranged to be the same, for example, 45°, such that when the optical structure is applied to the display device, an effective viewing angle of the display device may be located directly in front of it.

Obviously, the contact interface between the first optical film 10 and the second optical film 20 is not limited to only include two portions (i.e., first portions B₁ and second portions B₂). The contact interface may have any one of other structures. For example, a projection of the contact interface on the first vertical plane which is perpendicular to the first incident surface A may form a periodically repeated arc line, as shown in FIG. 1. Here, the arc line may be a circular arc line, an elliptical arc line or of other irregular shapes, as long as the light can be converged through the refraction.

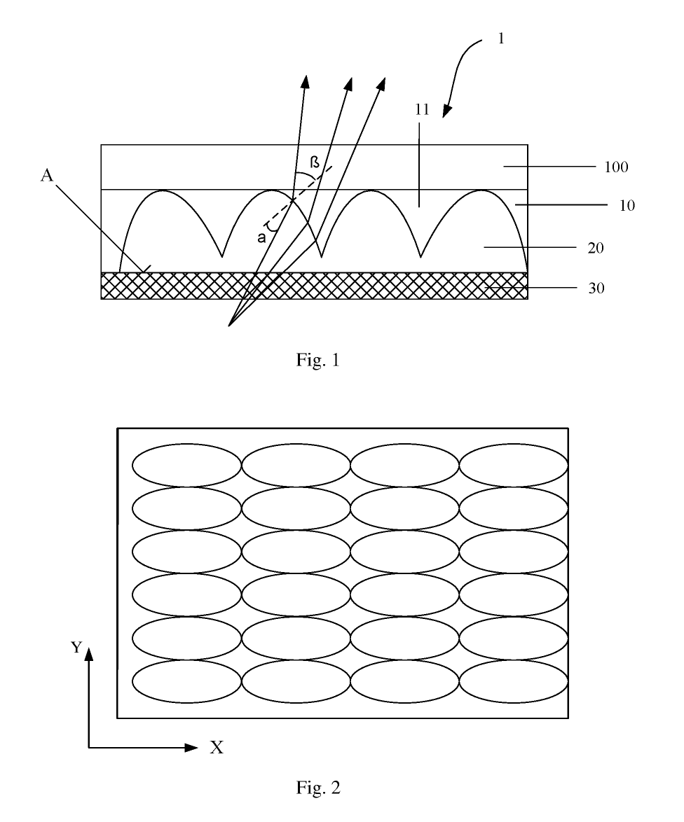

When the contact interface between the first optical film 10 and the second optical film 20 is of a concavo-convex structure, the concavo-convex structure is not limited to be strip-like protrusions, but also may include a plurality of independent dot-like protrusions. Specifically, as shown in FIG. 1 and FIG. 2, the contact interface includes a plurality of first convex surfaces arranged in the first direction X, and each of the first convex surfaces includes a plurality of second protrusion units arranged in the second direction Y and protruding toward the light-exiting side. Here, the first direction X is perpendicular to the second direction Y, and a plane where the first direction X and the second direction Y are located is parallel to the first incident surface A. An intersecting surface of each of the second protrusion units, which is parallel to the first incident surface A, may be of, but is not limited to, a circular, elliptical or polygonal shape. FIG. 2 is a schematic view showing that the intersecting surface of the second protrusion unit is of a elliptical shape.

In the above embodiments, the contact interface between the first optical film 10 and the second optical film 20 includes convex surfaces protruding toward the light-exiting side, that is, the contact interface between the first optical film 10 and the second optical film 20 is not in a plane.

In the practical application, as shown in FIG. 5, the contact interface B between the first optical film 10 and the second optical film 20 may be arranged to be parallel to the first incident surface A, and the contact interface B is in a plane. Here, the refractive index of the second optical film 20 proximate to the light-entering side is less than that of the first optical film 10 away from the light-entering side. As a result, the incident angle α of light at the contact interface B is larger than the refraction angle β, such that the angle between the refracted light and the first incident surface A is larger than that between the incident light and the first incident surface A, thereby achieve the convergence of light.

In some embodiments, the refractive indexes of all optical films of the optical structure 1 may be arranged in an ascending order or in a descending order in a light transmitting direction, such that the light can be refracted at each of contact interfaces between the adjacent optical films, so as to converge the light, as described above.

As shown in FIG. 3, taking that the optical structure 1 only includes two adjacent films, i.e., the first optical film 10 and the second optical film 20, as an example, the optical structure 1 in some embodiments of the present disclosure specifically includes a base 100, the first optical film 10 arranged on the base 100, and the second optical film 20 covering the first optical film 10. The base 100 may be a transparent substrate, such as a glass substrate, a quartz substrate, an organic resin substrate. The first optical film 10 includes a plurality of strip-like protrusion structures 11 protruding towards the light-entering side and a plurality of stripe-like groove structures 12 recessing towards the light-exiting side, and the protrusion structures 11 and the groove structures 12 are arranged alternately. A projection of the strip-like protrusion structures 11 on the first vertical plane perpendicular to the first incident surface A are a broken line, and the first vertical plane is parallel to an arrangement direction of the plurality of strip-like protrusion structures 11 and perpendicular to an extending direction of the strip-like protrusion structures 11. A projection of the contact interface between the first optical film and the second optical film in FIG. 3 on the light incident surface is shown in FIG. 4. The contact interface between the first optical film 10 and the second optical film 20 is a concavo-convex surface, and the refractive index of second optical film 20 is larger than that of the first optical film 10.

As shown in FIGS. 6-8, the method for manufacturing the optical structure 1 as shown in FIG. 3 may include the following steps.

First, a base 100 is provided. As shown in FIG. 6 and FIG. 7, a first organic resin film 101 is formed on the base 100 through a filming process, such as an evaporation process and a spinning process. Then, the first organic resin film is coated with photoresist. The photoresist is exposed by using a mask plate and then developed to form a photoresist reserved region and a photoresist unreserved region. The organic resin film 101 in the photoresist unreserved region is etched off to form strip-like groove structures 12 recessed towards the light-exiting side. The closer to the light-entering side the organic resin film 101 is, the longer the etching time is, such that the inner diameters of the groove structures 12 are different from each other, such that the structure as shown in FIG. 7 is formed. The remaining photoresist is removed to form the first optical film 10, and form the strip-like protrusion structures 11 protruding towards the light-entering side between the groove structures 12. Then, a second organic resin film is formed to cover the first optical film 10 through a filming process, such as an evaporation process and a spinning process so as to form the second optical film 20. A surface of the second optical film 20 has good flatness. A contact interface between the first optical film 10 and the second optical film 20 is of a concavo-convex structure, as shown in FIG. 8.

At this point, the optical structure 1 in some embodiments of the present disclosure is formed.

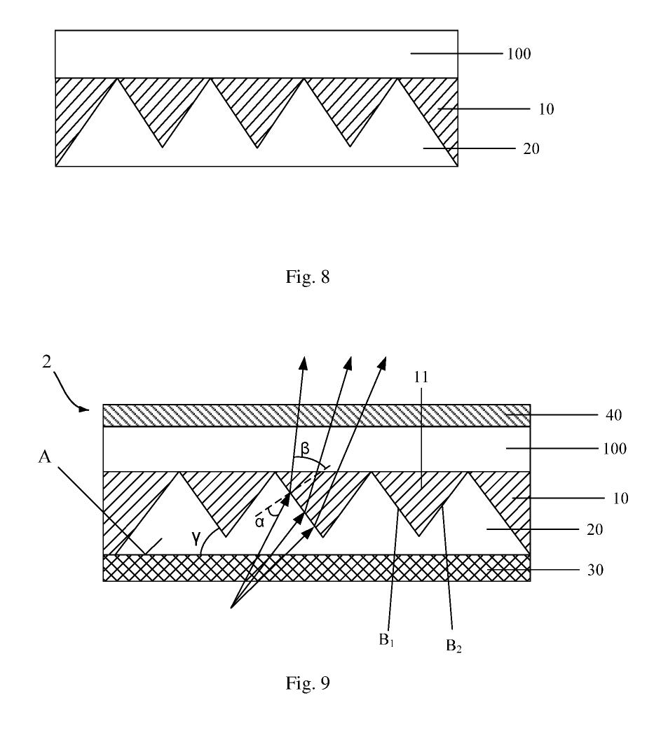

As shown in FIG. 9, the present disclosure further provides in some embodiments a display substrate 2, including the optical structure 1 as shown in FIG. 3. The optical structure 1 is arranged on the display substrate at a light-entering side, such that the display substrate 2 is capable of converging light and increasing the brightness of the light. As compared with the use of an optical element, such as a prism sheet or a brightness enhancement film, the optical structure 1 does not affect the thickness of the display substrate 2.

Optionally, the optical structure 1 is arranged on the base of the display substrate 2; hence, a separate base for the optical structure is not needed and the thickness of the display substrate 2 is reduced.

Further, in order to ensure the optical characteristic of the optical structure, a protection layer 30 may be arranged on the second optical film 20, as shown in FIG. 9. The protection layer 30 covers the optical structure, and is configured to prevent the optical film from being damaged by mechanical stress such as scratching. The material of the protective layer 30 may include an inorganic insulating material such as a nitride, an oxide, or an nitrogen oxide. The inorganic insulating material has high light transmittance and hardness, not only can protect the optical structure 1, also will not affect the light transmittance of the optical structure 1.

When the display substrate 2 is an array substrate, the display substrate 2 may further include a display film 40 for displaying, as shown in FIG. 9. For a liquid crystal display device, the display film 40 may include thin film transistors, pixel electrodes and the like. For an organic light emitting diode display device, the display film 40 may include organic light emitting diodes, a pixel definition layer and the like.

In the embodiments of the present disclosure, the display film 40 and the optical structure 1 may be arranged on two opposite sides of the base 100, respectively, to further reduce the thickness of the module. For a liquid crystal display device, the optical structure 1 is arranged proximate to the backlight module, such that light from the backlight module is converged by the optical structure first and then emitted from the display film 40 to achieve the displaying.

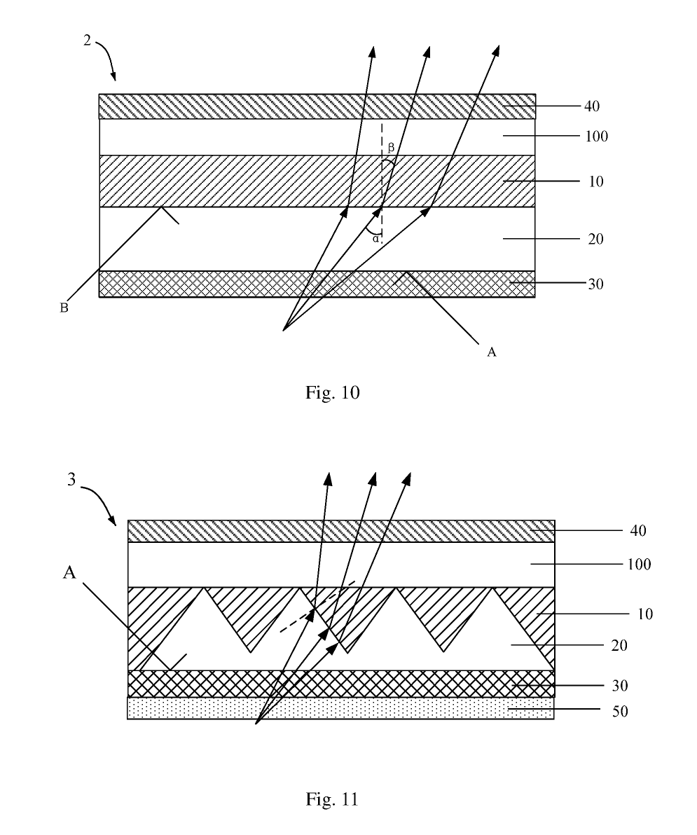

FIG. 10 shows another example of the display substrate of the embodiments of the present disclosure. It is different from the display substrate in FIG. 9 in that the display substrate in FIG. 10 includes the optical structure as shown in FIG. 5.

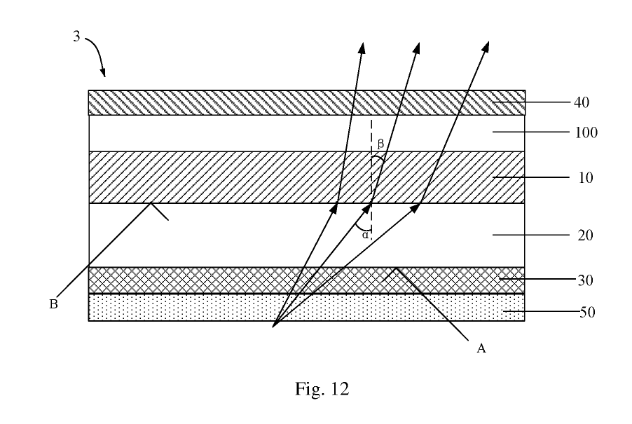

As shown in FIG. 11 and FIG. 12, the present disclosure further provides in some embodiments a display device 3. The display devices 3 in FIG. 11 and FIG. 12 include the display substrates 2 in FIG. 9 and FIG. 10, respectively, so as to increase the display brightness of the display device 3 without increasing the thickness thereof. When the display device 3 is a liquid crystal display device, the optical structure may be arranged between the display substrate 2 and the backlight module 50. Optionally, the optical structure 1 may be arranged on the base 100 of the display substrate 2 at a side proximate to the backlight module 50.

The display device may specifically be any product or component having a display function, such as a display panel, an electronic paper, a mobile phone, a tablet computer, a television, a monitor, a notebook computer, a digital photo frame, or a navigator.

The above are merely the preferred embodiments of the present disclosure. A person skilled in the art may make further modifications and improvements without departing from the principle of the present disclosure, and these modifications and improvements shall also fall within the scope of the present disclosure.

1. An optical structure, comprising: at least two optical films, wherein at least two adjacent optical films have different refractive indexes; and
the optical structure is capable of converging light passing through the optical structure.

2. The optical structure according to claim 1, wherein
the at least two adjacent optical films comprise a first optical film and a second optical film which are adjacent to each other; and
a contact interface between the first optical film and the second optical film is of a concavo-convex structure, the second optical film is arranged proximate to a light-entering side, and a refractive index of the second optical film is larger than that of the first optical film.

3. The optical structure according to claim 2, wherein
an angle γ between a first incident surface and a tangential plane of the contact interface satisfies 0°<γ≤45°, wherein incident light enters the second optical film through the first incident surface.

4. The optical structure according to claim 3, wherein
the contact interface comprises a plurality of first protrusion units protruding toward a light-exiting side;
the plurality of first protrusion units is arranged in a first direction, and each of the first protrusion units is a strip-like protrusion extending in a second direction; and
the first direction is perpendicular to the second direction, and a plane where the first direction and the second direction are located is parallel to the first incident surface.

5. The optical structure according to claim 4, wherein
projections of the first protrusion units on a first vertical plane form a broken line; and
the first vertical plane is perpendicular to the first incident surface and parallel to the first direction.

6. The optical structure according to claim 5, wherein
the broken line comprises first portions and second portions ;
an angle between each of the first portions and the first incident surface is 45°; and
an angle between each of the second portions and the first incident surface is 45°.

7. The optical structure according to claim 4, wherein
a projection of each of the first protrusion units on a first vertical plane form an arc line; and
the first vertical plane is perpendicular to the first incident surface and parallel to the first direction.

8. The optical structure according to claim 3, wherein
the contact interface comprises a plurality of first convex surfaces arranged in a first direction;
each of the first convex surfaces comprises a plurality of second protrusion units arranged in a second direction and protruding toward a light-exiting side;
the first direction is perpendicular to the second direction; and
a plane where the first direction and the second direction are located is parallel to the first incident surface.

9. The optical structure according to claim 8, wherein an intersecting surface of each of the second protrusion units is of a circular, elliptical or polygonal shape and parallel to the first incident surface.

10. The optical structure according to claim 1, wherein
the at least two adjacent optical films comprise a first optical film and a second optical film which are adjacent to each other;
a contact interface between the at least two adjacent optical films is parallel to an incident surface, wherein incident light enters the at least two adjacent optical films through the incident surface; and
a second optical film is proximate to a light-entering side and has a refractive index less than that of the first optical film.

11. The optical structure according to claim 1, wherein
the at least two optical films in a light transmitting direction are provided with the refractive indexes in an ascending order or in a descending order.

12. The optical structure according to claim 1, wherein the optical films are made of organic materials.

13. A display substrate, comprising:
the optical structure according to claim 1, wherein the optical structure is arranged on the display substrate at a light-entering side.

14. The display substrate according to claim 13, wherein
the optical structure is arranged on a base of the display substrate; and
the display substrate further comprises a protection layer covering the optical structure.

15. The display substrate according to claim 14, wherein
the protection layer is made of an inorganic insulating material that is transparent.

16. A display device, comprising the display substrate according to claim 13.

17. A method for manufacturing an optical structure, comprising:
providing a base;
forming a first organic material film on the base; and
forming a second organic material film on the first organic material film,
wherein a refractive index of the first organic material film is different from that of the second organic material film.

18. The method according to claim 17, wherein forming the first organic material film on the base comprises:
forming a first organic material film on the base;
coating the first organic material film with photoresist, and exposing and developing the photoresist by using a mask plate to form a photoresist reserved region and a photoresist unreserved region;
etching off the first organic material film in the photoresist unreserved region to form strip-like groove structures; and
peeling off the remaining photoresist to form the first organic material film, wherein strip-like protrusion structures are formed between the strip-like groove structures;
the strip-like groove structures and the strip-like protrusion structures are arranged alternately in a first direction and extend in a second direction; and
the first direction is perpendicular to the second direction; and
a plane where the first direction and the second direction are located is parallel to a light incident surface.

19. The method according to claim 17, wherein forming the second organic material film on the first organic material film comprises:
forming, on the first organic material film, the second organic material film having a refractive index larger than that of the first organic material film, wherein an angle γ between an incident surface and a tangential plane of a contact interface satisfies 0°<γ<45°, wherein the contact interface is between the first organic material film and the second organic material film, and the incident light enters the second organic material film through the incident surface.

20. The method according to claim 17, wherein
forming the second organic material film on the first organic material film comprises: forming, on the first organic material film, the second organic material film having a refractive index less than that of the first organic material film,
wherein a contact interface between the first organic material film and the second organic material film is parallel to an incident surface of light entering the second organic material film.
